(19) United States
(12) Patent Application Publication
(10) Pub. No.: US 2020/0247029 A1
(43) Pub. Date: Aug. 6, 2020

(54) METHOD AND APPARATUS FOR PRODUCING LIQUID-CONTENTS-FILLED CONTAINERS FROM PREFORMS BY CONTENTS BEING INTRODUCED INTO THE PREFORM UNDER PRESSURE

(71) Applicant: KHS Corpoplast GmbH, Hamburg (DE)

(72) Inventors: Michael LITZENBERG, Börnsen (DE); Michael LINKE, Hamburg (DE); Gerhard KLÖPPER, Hamburg (DE); Karl-Heinz BALKAU, Oststeinbek (DE); Werner LESINSKI, Ahrensburg (DE)

(21) Appl. No.: 15/774,352

(22) PCT Filed: Dec. 14, 2016
(86) PCT No.: PCT/EP2016/002104

§ 371 Date: May 8, 2018

(30) Foreign Application Priority Data
Dec. 14, 2015 (DE) 10 2015 016 124.5
Dec. 14, 2015 (DE) 10 2015 016 125.3

(51) Int. Cl. B29C 49/06; B29C 49/12

(52) U.S. Cl. CPC B29C 49/06; B65B 3/022; B29C 49/12

(57) ABSTRACT

The present invention relates to a method and an apparatus for producing containers filled with a liquid filling material from preforms by introducing pressurized filling material into the preform. The object of the invention is to propose such a method and such an apparatus in which both the desired filling pressure and the desired volumetric flow rate of the filling material are reliably available throughout the entire molding and filling phase. The object of the invention is achieved by a method in which the filling material is pressurized by a pressure pump 7 and is introduced into the preform 1 through a filling valve 6 at a molding and filling station 3, said method being characterized in that, when the filling valve 6 is closed, a pressure accumulator 10 disposed between the pump 7 and the filling valve 6 is pressurized by the pump 7 and filled with a volume of filling material, and when the filling valve 6 is open, the pressure accumulator 10 delivers the accumulated pressurized filling material to the preform 1. The object of the invention is further achieved by a corresponding apparatus that comprises a pressure pump 7 and a filling valve 6, connected to one another by a feed line 2, characterized in that said apparatus comprises a pressure accumulator 10, disposed in the feed line 2 between the pressure pump 7 and the filling valve 6.

The present invention relates to a method and an apparatus for producing containers filled with a liquid filling material from preforms by introducing pressurized filling material into the preform.

A preform in this context is understood as a prefabricated blank, produced by injection molding, for example. Customarily, containers, in particular bottles, are molded in a blow-molding process by a molding gas flowing under pressure into a preheated preform, after which the containers are filled with a filling material, in particular a liquid filling material, in a second step.

In the production of containers from preforms, it is characteristic for different molds to be used for producing the preform and for producing the container.

The production of containers from preforms as described in the present invention is to be distinguished from extrusion blow-molding methods, which are foreign to the classification in question, and in which the molten raw material is extruded directly into a blow mold that fixes the contours of the container, and immediately thereafter, the container is inflated. In such extrusion blow-molding methods, no preform is produced.

To streamline the production of containers from preforms, methods have recently been developed in which the preheated preform can be shaped and filled in a single step by introducing the liquid filling material under pressure, rather than a pressurized gas. Such a method is known, e.g., from DE 10 2010 007541 A1.

To enable a preform to be shaped into a container, it is conditioned thermally, in particular it is heated and provided with a suitable temperature profile. In this process, the body of the preform is heated e.g. to approximately 120° C., at which point it can be shaped, while the temperature in the mouth region is kept significantly lower because the preform is held at its mouth region in the molding and filling machine, and cannot be allowed to deform in its mouth region under the holding forces customarily employed there. For thermal conditioning, a device for producing filled containers is equipped with a heating section, along which the preforms are guided while being provided with the desired temperature profile.

The molding process must then proceed very rapidly, so that the heat stored in the preform will be sufficient for the preform to remain plastically deformable until the molding process is complete. When liquid filling material is used for molding, the volume that is required for the container in its finished shape must therefore be supplied to the preform under high pressure and within a short time interval. Typical filling times range from 100 to 150 ms, necessitating volumetric flow rates of up to 20 liters per second or more, and pressures of up to 40 bar.

The start of the molding process is typically assisted by a stretch rod, which is inserted into the preform and applies mechanical pressure to the base of the preform, stretching the preform, and which then guides the preform base to ensure symmetrical formation of the container. To shape the preform into a container, a minimum filling pressure is required, based on the material and the shape of the preform and of the container to be produced; at the start of the shaping phase, a higher pressure may be beneficial for initiating the shaping process.

In industrial processes, preforms are supplied in cycles to the molding and filling station of a machine for producing filled containers, and are molded and filled in succession. During the filling period, high volumetric flow rates are required, whereas during the cycle periods between two filling cycles, there is no flow of filling material.

These required high volumetric flow rates are difficult to achieve using continuously running pumps, especially since full power is needed only for very short periods of time. For the hydraulic molding and filling of containers, piston pumps are therefore used, the displacement volume of which is equivalent to or matches the quantity of filling material required. The piston is driven hydraulically or pneumatically by a linear motor, and the filling material located in the cylinder of the piston pump is forced into the preform or into the container being molded.

The reaction time of a piston pump is long as compared with the filling time, so that, particularly at the start of a molding and filling operation, the desired volumetric flow rate is not achieved, and a satisfactory, replicable distribution of the material of the preform in the molded container cannot be guaranteed.

In addition, depending on the design of the filling apparatus, a plurality of containers may be filled in overlapping operations at a plurality of filling stations. With a piston pump of the type described above, an adequate supply of filling material cannot be guaranteed. The beginning and the ending of successive filling operations will not proceed seamlessly and harmoniously, and as a result, pressure pulsations may occur in the distribution system.

The object of the invention is to propose a method and an apparatus for producing containers filled with a liquid filling material from preforms by introducing pressurized filling material into the preform, in which both the desired filling pressure and the desired volumetric flow rate of the filling material are reliably maintained throughout the entire molding and filling phase.

The object of the invention is achieved by a method for producing containers filled with a liquid filling material from preforms by introducing pressurized filling material into the preform, wherein the filling material is pressurized by means of a pressure pump and is introduced into the preform through a filling valve at a molding and filling station.

The method according to the invention is characterized in that, when the filling valve is closed, a pressure accumulator disposed between the pump and the filling valve is pressurized by the pump and filled with a volume of filling material, and when the filling valve is open, the pressure accumulator delivers the filling material that has been accumulated under pressure to the preform.

The method of the invention has the advantage that a continuously running pump can be used. Although such pumps are capable of achieving the high pressures that are required, they typically cannot achieve the high volumetric flow rate necessary for filling. According to the invention, during the cycle periods between two filling operations, when the filling valve is closed, the pump pumps filling material under pressure to the pressure accumulator, filling the pressure accumulator with a volume of filling material.

In a molding and filling operation, a certain minimum pressure is required to deform the preform. Higher pressures may be used, and are advantageous particularly during the initial phase of shaping, to initiate the shaping process. The start of the shaping process may also be assisted by a stretch rod. The provision of a stretch rod is a preferred embodiment.

It is also important that a certain maximum pressure not be exceeded, firstly because the system components are not designed for this, and secondly because the shaping of the preform into the container would not proceed in a controlled manner.

The pressure accumulator that is used should therefore advantageously have a preload pressure that is equal to the minimum molding pressure. The pressure of the pressure accumulator increases as it is filled with the filling material. The pressure increase may be negligible or substantial, depending on the design and the volume of the pressure accumulator. For example, a preload pressure of 36 bar may be used, which increases to 40 bar when filled with the desired volume of filling material. Pressure reducers are preferably provided upstream of the molding and filling station, in case the pressure that is reached in the accumulator exceeds the desired maximum filling pressure.

The pump must be capable of applying the level of pressure to be reached in the pressure accumulator. Advantageously, the pump achieves a pressure that is equal to the maximum filling pressure. In case the pump pressure is higher, appropriate means for reducing pressure are again preferably provided.

The design described above by way of example has the advantage that the pressure that is built up in the pressure accumulator is initially high during the molding and filling operation, enabling the process of shaping the preform to be initiated more easily. The start of the shaping process may also be facilitated by the assistance and guidance of a stretch rod, for example.

Once the shaping process has been initiated, a lower pressure is typically sufficient for its completion. The drop in pressure from the pressure accumulator over the course of the molding and filling operation is therefore harmless as long as a certain minimum pressure is maintained.

The volume of the pressure accumulator should preferably be equal at least to the volume of the container to be molded and filled, i.e. substantially to the volume of the mold in which the preform is being shaped into the container. Depending on the use, however, the volume of the pressure accumulator may also be higher, particularly if the method is implemented using a molding and filling apparatus in which containers can be molded and filled in overlapping operations at a plurality of molding and filling stations.

The object according to the invention is also achieved by an apparatus for producing containers that are filled with a liquid filling material from preforms by introducing pressurized filling material into the preform at a molding and filling station, said apparatus comprising a pressure pump and a filling valve, connected to one another via a feed line. The apparatus according to the invention is characterized in that it includes a pressure accumulator, disposed in the feed line between the pressure pump and the filling valve.

The pressure accumulator is preferably a pressurized gas accumulator, which is preloaded with a pressure equal to the minimum molding and filling pressure.

The pump is preferably a continuously running pump. However, any other type of pump that is capable of achieving sufficient pressure is likewise suitable. The working pressure of the pump should preferably be equal to at least the minimum filling pressure, but advantageously and preferably is equal to the maximum filling pressure. When higher pressures are used, appropriate pressure limiters are preferably provided in the liquid path upstream of the filling valve.

Outside of a molding and filling operation, i.e. in particular when the filling valve is closed, the pump pumps pressurized filling material into the pressure accumulator. The pump pumps liquid into the pressure accumulator as long as the pressure achieved by the pump is greater than the pressure prevailing in the pressure accumulator. A volume that is preferably equal at least to the volume required for a molding and filling operation, i.e. substantially to the volume of the mold in which the preform will be shaped into the filled container, is accumulated in the pressure accumulator.

When the maximum volume of the pressure accumulator is reached or the pressure in the pressure accumulator increases to the desired level, the pump will run idle or the filling material will be discharged via a return line having a pressure relief valve.

For the actual molding and filling process, the filling valve is opened. Due to the features of the invention, the full molding and filling pressure that has been built up in the pressure accumulator is available immediately. The volumetric flow required for the molding and filling process can be supplied by the pressure accumulator, independently of pump output.

With the invention, it is no longer necessary to use a pump that can deliver a high volumetric flow for the apparatus. It is enough for the pump to supply a sufficiently high pressure, and for the pump output to be high enough to fill the pressure accumulator between two filling operations. The pump output needs only to correspond to the volume of filling material filled per unit of time. The short-term high volumetric flow rates are supplied by the pressure accumulator.

In an exemplary embodiment of the invention, a damping element may advantageously be disposed in the feed line. A pressurized gas accumulator, in particular, is a suitable damping element. Such a pressurized gas accumulator can be equipped with a gas charge, which is sealed off from the infeed line by a membrane in the accumulator. A biased piston in a cylinder, biased by spring force or by pressurized gas, for example, may also be used as a damping element.

If, at the end of a molding and filling operation, a sudden increase in pressure occurs, this pressure increase is at least partially offset by the damping element, e.g. the gas cushion in the pressure accumulator is compressed or the spring is tensioned, thereby damping the developing pressure wave.

If a pressurized gas accumulator is used as the damping element, the pressure accumulator for this purpose should have a preload pressure or a preload force that is equal to or slightly higher than the maximum filling pressure. In this way, at the normal filling pressure, the pressure accumulator will not be tensioned and will retain its capacity to absorb the pressure wave at the end of the molding and filling operation. Alternative damping elements should be similar in design, i.e. they should allow the normal molding and filling pressure to pass essentially without damping to the molding and filling station, but should effect a damping of the sudden pressure increase at the end of the molding and filling operation.

It has proven advantageous for the aforementioned pressure accumulator to be oriented relative to the molding and filling station such that the pressure wave traveling in the line system between the molding and filling station and the pressure accumulator will strike the membrane at right angles, i.e. such that the direction of propagation of the pressure wave is perpendicular to the membrane. This is ensured, in particular, if the membrane of the pressure accumulator is perpendicular to the axis of the preform. Due to the particular propagation of waves inside small diameter lines and the reflection thereof on the line walls, however, this effect can also be achieved through a different alignment with appropriately curved lines.

For the effective damping of the propagating pressure wave and for protecting the broadest possible areas of the apparatus, it is advantageous for the damping element to be located near the molding and filling station, in particular near a molding and filling head of the molding and filling station. This will ensure that the pressure wave can travel in only a very spatially limited area of the apparatus, and will be effectively damped. More remote components of the apparatus are effectively protected. In particular, it has proven advantageous for the damping element to be located between the molding and filling station and the first pressure surge-sensitive element of the apparatus.

Since the pressure surges displace only a very small volume, the damping element can be designed as correspondingly small. For example, it is sufficient for a pressurized gas accumulator to have a maximum liquid capacity of less than 500 ml, in particular less than 300 ml and preferably less than 150 ml.

This enables pressure surges, the levels of which cannot be clearly determined, to be controlled with only one simple element. System components are protected against pressure surges, for which safety valves are ineffective.

In the following, an exemplary embodiment of the invention will be described in greater detail with reference to the accompanying FIGURE.

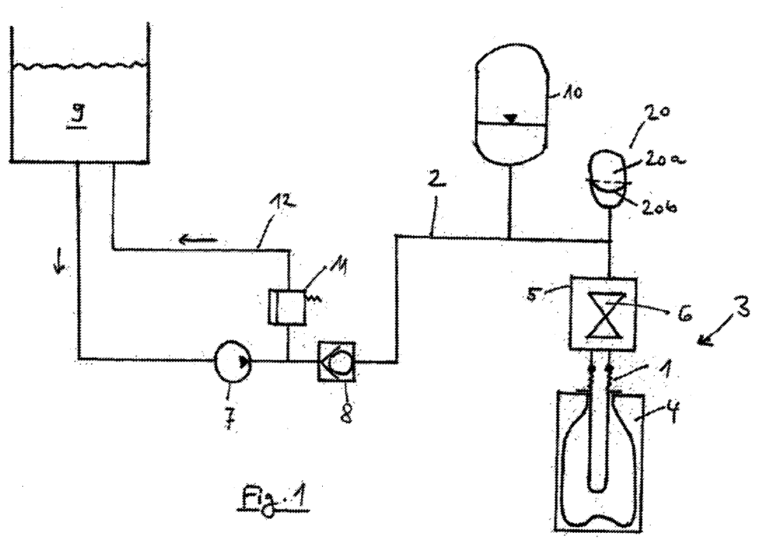

FIG. 1 is a diagram illustrating the configuration of an exemplary embodiment of an apparatus according to the invention.

It will be obvious to a person skilled in the art that the exemplary embodiment illustrated here is intended merely to illustrate the principle of the invention, and that it is rendered only schematically and not to scale. In particular, the relative dimensions and proportions of the elements in the diagram are intended merely as illustrative. The actual dimensions and proportions may be determined by a person skilled in the art based on his knowledge in the art. Furthermore, only those components that are necessary for an understanding of the invention are shown. Actual apparatus may include additional components.

The apparatus shown includes a molding and filling station 3, in which a preform 1 is shaped into a filled container inside a mold 4. For this purpose, the molding and filling station 3 is equipped with a molding and filling head 5 having a filling valve 6, which is connected to a feed line 2 through which filling material can be supplied under pressure from a reservoir 9 to the molding and filling station 3.

To mold and fill a container, the molding and filling head 5 is placed on the mouth of preform 1, forming a tight seal, and filling material is fed at a pressure of 36 to 40 bar to preform 1 within a maximum filling time of 150 ms. For a 1.5 liter bottle, this requires a volumetric flow rate of the filling material of at least 10 liters per second.

For this purpose, the apparatus is equipped with a pump 7, which runs continuously and achieves a pressure of 40 bar. Downstream of the pump, feed line 2 is equipped with a flow check valve 8.

The apparatus additionally includes a pressure accumulator 10, preloaded with a gas. The pressure accumulator is preloaded at 36 bar, for example, and can accommodate a volume of 1.5 liters at a pressure of 40 bar, for example. The running pump 7 pressurizes the filling material in feed line 2 to 40 bar, so that the gas in pressure accumulator 10 is compressed and the pressure accumulator admits 1.5 liters of the filling material. When a pressure of 40 bar is reached, the pressure accumulator stops admitting filling material. The filling material being conveyed by pump 7 is returned to reservoir 9 via pressure relief valve 11 and return line 12.

Once pressure accumulator 10 is completely filled, filling valve 6 can be opened. The filling material stored in pressure accumulator 10 flows through molding and filling head 5 and into preform 1 at the initial pressure of 40 bar and at a high volumetric flow rate, with the action of the filling material shaping the preform into the container while simultaneously filling it inside mold 4. The pressure in accumulator 10 then drops to 36 bar, which is sufficient for molding the container, until the molding and filling of the container are completed.

Pressure accumulator 10 responds quickly and without delay and, unlike the pump 7, is capable of supplying the volumetric flow required for the short filling time. The container can thus be molded from the thermally conditioned preform 1 before the temperature of the preform 1 drops below the level at which the preform is moldable.

Once molding and filling valve 6 has been closed, the molded container can be separated from molding and filling head 5 and further processed, in particular by sealing, labeling, etc. Pump 7 continues to run, refilling pressure accumulator 10 for the next molding and filling operation.

The apparatus according to the invention has the advantage that a simple pump 7 with a conventional output capacity can be used, since the high volumetric flow rate required briefly for the molding and filling operation can be stored by pressure accumulator 10 and supplied as needed.

In an industrial system, the output capacity of pump 7 must be designed to correspond to the fill quantity per unit of time. The high volumetric flow rates required during the molding and filling phase are achieved by filling and emptying pressure accumulator 10. The volume of pressure accumulator 10 should be sufficient to accommodate the container volume during the molding and filling of a container. When a plurality of containers are molded and filled in overlapping operations at different molding and filling stations 3 connected to pressure accumulator 10, the volume of pressure accumulator 10 must be increased accordingly. Of course, it is also possible for the dimensions of the accumulator in terms of volume available for filling material to be increased.

A damping element 20 may optionally be connected to feed line 2. This may be a pressurized gas accumulator, for example, in which a pressurized gas cushion 20a is trapped behind a membrane 20b. Here, the gas pressure is equal to the maximum molding and filling pressure of the apparatus, for example 38 bar. However, the molding and filling pressure used may be different depending on the container to be formed. Typically, the pressure of the gas cushion in the pressure accumulator may be between 36 and 44 bar, preferably between 40 and 42 bar.

When a preform 1 is shaped into a filled container by the introduction of filling material within approximately 100 to 150 ms, the high volumetric flow of the filling material causes a pressure surge once the container is fully formed and its wall is in contact with the wall of mold 4. A pressure peak occurs, which travels backward through the system in the form of a pressure wave. The level of the pressure peak is difficult to calculate. However, the components of the system are typically designed to withstand only the filling pressure plus a safety margin. Constant pressure surges can damage the components.

Damping element 20 can dampen the pressure wave by briefly admitting a small volume of filling material. For this purpose, damping element 20 is disposed close to molding and filling head 5, thereby restricting the propagation of the pressure wave to a limited area of the system and effectively protecting the components disposed upstream.

Although pressure propagates in all directions in the system of lines, pressure surges that occur travel at a finite speed in the form of a wave. It is therefore advantageous for damping element 20 to be disposed such that the propagation direction of the wave is roughly perpendicular to the membrane, as this enables particularly effective damping of the pressure wave.

Although pressure accumulator 10 and damping element 20 appear to be structurally similar, they possess significant differences in detail.

Specifically, pressure accumulator 10 should always be designed as greater than the volume of a container to be produced, whereas the volume of damping element 20 can be much smaller than the container volume.

Furthermore, damping element 20 is preferably disposed close to or even integrated into molding and filling head 5, whereas pressure accumulator 10 feeds a supply line leading to molding and filling head 5, and even longer pipe routes between pressure accumulator 10 and molding and filling head 20 are non-problematic.

Finally, machines having a plurality of molding and filling stations 3 will preferably each have one damping element 20 per molding and filling station 3 or per molding and filling head 5, whereas multiple or all molding and filling stations 3 are preferably fed by the same pressure accumulator 10.

1. A method for simultaneously producing a container from a preform and filling the container with a liquid filling material, the method comprising:
introducing the liquid filling material into the preform under pressure;
wherein the liquid filling material is pressurized by a pressure pump and is introduced into the preform through a filling valve at a molding and filling station,
wherein, when the filling valve is closed, a pressure accumulator disposed between the pump and the filling valve is pressurized by the pump and is filled with a volume of liquid filling material, and
wherein, when the filling valve is open, the pressure accumulator delivers the liquid filling material pressurized in the pressure accumulator to the preform.

2. The method according to claim 1, wherein the pump is a continuously running pump.

3. The method according to claim 1, wherein the pump has a working pressure that is equal to at least a maximum filling pressure.

4. The method according to claim 1, wherein the pressure accumulator has a preload pressure that is equal to a minimum molding and filling pressure.

5. The method according to claim 3, wherein, at the working pressure of the pump, a volume of filling material admitted to the pressure accumulator is equal to at least a volume of a container to be molded from the preform.

6. An apparatus for simultaneously producing a container from a preform and filling the container with a liquid filling material by introducing the liquid filling material under pressure into the preform while the preform is disposed within a mold at a molding and filling station, said apparatus comprising:
a pressure pump and a filling valve, which are connected to one another by a feed line; and
a pressure accumulator disposed in the feed line between the pressure pump and the filling valve.

7. The apparatus according to claim 6, wherein the pump is a continuously running pump.

8. The apparatus according to claim 6, wherein the pump has a working pressure that is equal to at least a maximum filling pressure.

9. The apparatus according to claim 6, wherein the pressure accumulator has a preload pressure that is equal to a minimum molding and filling pressure.

10. The apparatus according to claim 6, wherein the pressure accumulator is a pressurized gas accumulator.

11. The apparatus according to claim 8, wherein, at the working pressure of the pump, a volume accommodated by the pressure accumulator is equal to at least a volume of the mold.

12. The apparatus according to claim 6, wherein a flow check valve is disposed between the pressure pump and the pressure accumulator.

13. The apparatus according to claims 6, wherein a damping element is disposed in the feed line (2).

14. The apparatus according to claim 13, wherein the damping element has a maximum liquid capacity of 500 ml.

15. The apparatus according to claim 13, wherein the damping element is disposed near the molding and filling station.

16. The apparatus according to claim 13, wherein the damping element is a pressurized gas accumulator.

17. The apparatus according to claim 13, wherein the damping element is a piston biased in a cylinder by a spring force or by gas pressure.

18. The apparatus according to claim 13, wherein the damping element has a maximum liquid capacity of 300 ml.

19. The apparatus according to claim 13, wherein the damping element has a maximum liquid capacity of 150 ml.

20. The apparatus according to claim 15, wherein the damping element is disposed near a molding and filling head of the molding and filling station.
